(19) United States
(12) Patent Application Publication
(10) Pub. No.: US 2015/0164747 A1
(43) Pub. Date: Jun. 18, 2015

(54) Pill Cylinder and Pill cutter

(71) Applicant: Richard Qi Li, Ocala, FL (US)

(72) Inventor: Richard Qi Li, Ocala, FL (US)

(21) Appl. No.: 14/106,715

(22) Filed: Dec. 14, 2013

(51) Int. Cl. A61J 7/00; A61J 1/03

(52) U.S. Cl. CPC A61J 7/0007; A61J 1/03

(57) ABSTRACT

The pill cutter is a pill container with a blade and cuts pills within the cap for the blade while the blade is not exposed at any time. A cutting board is hinged to the end of the cap and has a clamp, which holds the pill and is always aligned with blade. No visual alignment of pill and blade is needed. It is a safer, more convenient and more precise pill cutter

The pill cutter is a continuation of my patent application Ser. No. 13/329,185, titled Pill Pen With A Pill Cutter And Grinder. The pill cutter can either be part of the pill pen disclosed in this application as a segment with blade or a standalone pill cutter.

### BACKGROUND OF INVENTION

The pill cutters commonly used are characterized by a swing blade and v-shaped slot to position the pill. The shortcomings associated with such pill cutter are the exposed blade when the cutter is open, which poses a risk of accidental cutting injury, the mobility of the pill in the v-shaped slot which may result in inaccurate splitting, especially when the pill is of small size or irregular shape, and the need to visually align the pill with the blade before cutting. I have designed a pill cutter which doesn't expose the blade at any time, has a clamp to firmly hold the pill, doesn't need visual alignment before cutting and is small in size. It is safer, more convenient and more accurate than ones currently being used.

### SUMMARY OF INVENTION

As part of the pill pen of my design, the pill cutter is a cylindrical pill container with a blade at its end. The length of the cylindrical segment can be variable and and can be quite short and takes little space. The cylindrical segment with blade has several evenly spaced longitudinal short ridges which engage the longer slots in the interior wall of the cylindrical cap for the blade, so that the segment with blade can only move up and down instead of sidewise.

The cylindrical cap for the blade has a cover at its lower end. The interior surface of the cover functions as the cutting board for the blade and has a clamp with two arms to hold the pill for cutting. A spring wires is integrated in each arm to create gripping force. The two arms of the clamp form two loops, a smaller and a larger loop. The larger loop holds a regular size pill and the smaller loop holds a tiny pill or a half pill to be split again. Each arm has finely serrated surface for firm gripping. The cap for the blade is longer than the the pill pen segment with blade. Also, the pill pen segment with blade has two small flanges at its opening, which stops the upper end of the segment with blade from going lower than the upper end of its cap and therefore prevents the blade from being exposed below the lower end of the cap while the cover of the cap is open. The cover of the cap is of sufficient thickness. When the cover is closed, part of its thickness is within the cap and the interior surface of cover meets the blade, thus it functions as a cutting board.

The ridge-slot engagement only allows the segment with blade to move up and down within its cap and ensures that the blade is always aligned with the central line between the two arms of the clamp. Therefore one just places the pill between the two arms and close the cover of the cap. The pill is truly immobilized. Then the segment with blade is pressed down, which splits the pill equally. No visual alignment or estimate is necessary.

When a pill is split, the two arms are flexible and move apart slightly to accommodate the expanding volume created by the separated two pieces of the pill. However, in the case of a v-shaped slot, when a pill is cut into two, the increased volume can not expand and is squeezed by the fixed two arms of the v-shaped slot, which may cause the pill to chip.

A spring is fixated between the two arms of the clam with its wire being integrated in each arm to create gripping force. Two opposing short stubs at the end of each arm keep the two arms slightly apart, making space for the blade when the cover of the cap is closed.

Another version of pill cutter features a square pill container with a blade and has a similar clamp for pills on the cutting board. Two elastic wires which emanate from a spring press the two arms of the clamp to create gripping force. The cap for the blade is longer than the the pill container with blade. Also, the pill container with blade has two small flanges at its opening, which stops the upper end of the pill container with blade from going lower than the upper end of its cap and therefore prevents the blade from being exposed below the lower end of the cap while the cover of the cap is open.

A pill clamp which can hold more than one pills for cutting features an articulation in each of the two arms of the pill clamp, which keeps the two arms parallel to each other, which therefore are able to hold multiple pills at the same time. This clamp is applicable to both the cylindrical and square pill cutters.

Magnet can be used in place of the spring to bring the two arms of the pill clamp together. Two or three magnet tablets are embedded in the cutting board along the middle line while an iron bar is embedded in each arm of the pill clamp.

### BRIEF DESCRIPTION OF THE DRAWINGS

FIG. 1 shows the pill cutter as a cylindrical segment with a blade in the pill pen, which is disclosed in my patent application Ser. No. 13/329,185, titled Pill Pen With A Pill Cutter And Grinder.

FIG. 2 is the standalone pill cutter.

FIG. 3 shows the details of the clamp for pills.

FIG. 4 shows the pill cutter with a blade on a square pill container which is within its cap.

FIG. 5 shows the details of a pill clamp with an articulation in each of the two arms of the clamp, which keeps the two arms parallel to each other, which thus are able to hold multiple pills at the same time.

FIG. 6 shows a pill clamp with an articulation in each of its two arms, the longer segments of which are parallel to each other and thus are able to hold more than one pills to be spitted at the same time. A iron bar is embedded in each arm and two or three magnetic tablets are embedded in the cutting board along the middle line.

### DETAILED DESCRIPTION OF THE INVENTION

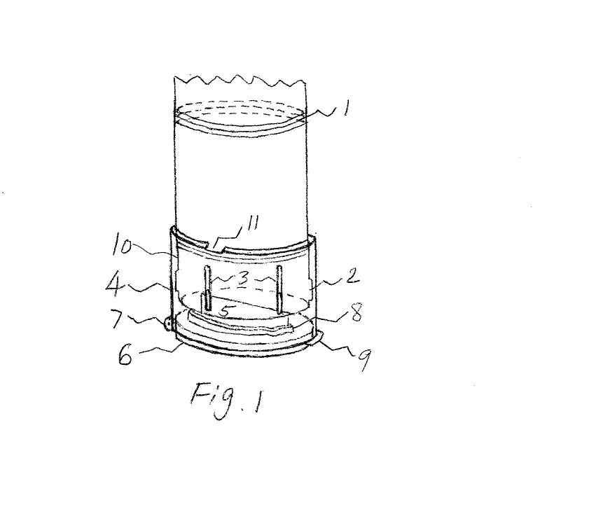

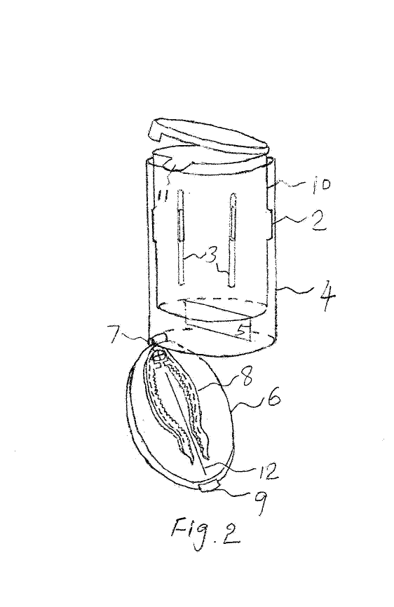

FIG. 1 and FIG. 2 show the pill cutter can be variable in its length.

FIG. 1 shows the pill cutter as part of the pill pen and is the last cylindrical segment of the pill pen. It is a shorter version. The successive cylindrical segments of the pill pen are joints together by spiral threads 1. The segment with blade has several evenly spaced longitudinal short ridges 2 on its surface, which are coupled to the longer slots 3 in its cap 4. The segment with blade moves up and down along the slots, but can not move sideways and therefore the blade remains aligned with center of the two arms of the clamp. The cap 4 for the blade 5 has a thick cover 6 at its end. The cover 6 is coupled to the cap 4 with a hinge 7. When the cover 6 is closed, part of its thickness is within the cap 4 and the blade 5 rests between the two arms 8 of the clamp for the pills. A tab 9 on the edge of the cover 4 can be grasped to open and close the cover and prevents the cover from going all the way into the cap.

The cap 4 for the blade is longer than the the pill pen segment 10 with blade 5. Also, the pill pen segment 10 with blade has two small flanges 11 at its opening, which stops the upper end of the segment 10 with blade from going lower than the upper end of its cap 4 and therefore prevents the blade from being exposed below the lower end of the cap at any time.

FIG. 2 shows a standalone pill cutter and is a longer version. The cylindrical segment 10 can be used as a pill box and has a cover. The cylindrical segment 10 with blade 5 has several evenly spaced longitudinal short ridges 2 on its surface, which are coupled to the longer slots 3 in its cap 4. The segment with blade 10 moves up and down along the slots 3, but can not move sideways.

The cap 4 for the blade 5 is longer than the the pill pen segment 10 with blade. Also, the pill pen segment with blade has two small flanges 11 at its opening, which stops the upper end of the segment with blade from going lower than the upper end of its cap 4 and therefore prevents the blade 5 from being exposed below the lower end of the cap 4 at any time. This would decrease the risk of accidental cutting injuries associated with the swing blade in the pill cutters currently being used.

The cap 4 for the segment 10 with blade and its cover 6 are joined together with a hinge 7. A tab 9 on the edge of the cover 4 can be grasped to open and close the cover and prevents the cover from going all the way into the cap. The cover 6 of the cap is opened and shows a clamp with two arms 8 to hold a pill. A middle line 12 between the two clamp arms 8 is marked on the cap's cover 6, which functions as the cutting board for the pills.

The slot 2 and ridge 3 coupling ensures that the segment with blade 10 moves only vertically along the slots 3 and the blade 5 is always aligned with the middle line 12 between the two clamp arms 8. Therefore, when a pill is placed on the marked middle line 12, the blade 5 will split it into equal halves. This obviates the need to visually align the cutting blade with a pill, as is the case with the pill cutters with a swing blade which are currently being used.

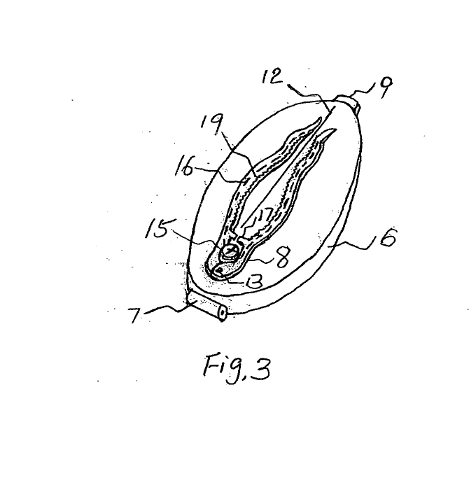

FIG. 3 shows the details of the clamp for the pills on the cutting board or cover of the cap for the segment with a blade. The cutting board 6 or the cover of the cap is coupled to the segment with blade with a hinge 7. The clamp has two arms 8 joined together at one end by a pivot 13 . A spring 15 is fixated in front of the pivot 13 and is between the two arms 8 of the clamp with its wire 16 being integrated in each arm to create gripping force. Two opposing short stubs 17 at the end of each arm keep the two arms slightly apart, making space for the blade when the cover of the cap is closed. The two arm of 8 of the clamp form two loops, a small one and large one. The large one is used to hold pills of regular size and small one to hold pill of tiny size or a half pill to be split again. Each arm has a finely serrated surface 19 for firm gripping of any pills, including the pills of small size and of irregular shape.

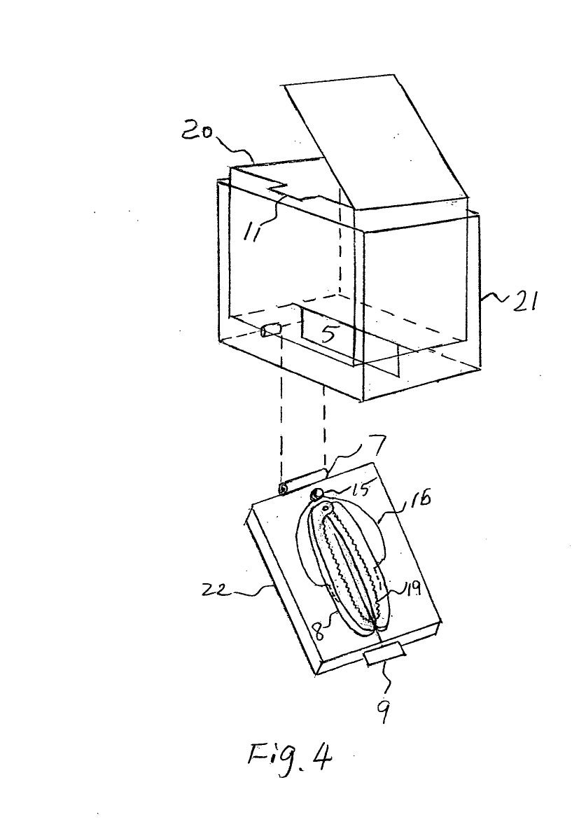

FIG. 4 shows a standalone square pill cutter. The square pill container 20 has a blade 5 a cover. The cap 21 for the blade 5 is longer than the the pill container 20 with a blade. Also, the pill container with blade has two small flanges 11 at its opening, which stops the upper end of the pill container from going lower than the upper end of its cap 21 and therefore prevents the blade 5 from being exposed below the lower end of the cap 21 at any time. This would decrease the risk of accidental cutting injuries associated with the swing blade in the pill cutters currently being used.

The cap 21 for the pill container 20 with blade and its cover or the cutting board 22 are joined together with a hinge 7. A tab 9 on the edge of the cover 22 can be grasped to open and close the cover and prevents the cover from going all the way into the cap. The cover 22 of the cap is opened and shows a clamp with two arms 8 to hold a pill. A middle line 12 between the two clamp arms 8 is marked on the cap's cover 22, which also functions as the cutting board for the pills. The blade 5 is always aligned with the middle line 12 between the two clamp arms 8. Therefore, When a pill is placed on the marked middle line 12, the blade 5 will split it into equal halves. This obviates the need to visually align the cutting blade with a pill, as is the case with the pill cutters with a swing blade which are currently being used. The two arms 8 of the clamps have finely serrated surfaces 19 for firm gripping of pills and are slightly curved. When the two arms 8 are closed, a gap is created in between to accommodate the blade 5.

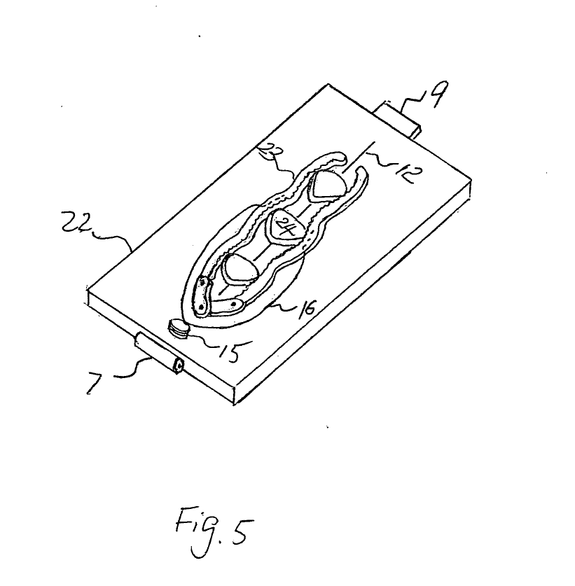

FIG. 5 shows the details of the clamp with an articulation in each arm 23 of the clamp. Each arm 23 has two segments, a short segment and a long segment, which are joined together by the articulation, which keeps the long segments of the two arms parallel to each other instead of diverging from the pivot, as in the case of two arms without articulation, which can hold only one pill. Each arm 23 has a finely serrated surface 19 for firm gripping of multiple pills 24. The cover 22 is coupled to the pill container 20 with blade with a hinge 7. Each arm 23 is pressed upon by an elastic wire 16 emanated from a spring 15, which is behind the pivot of the two arms.

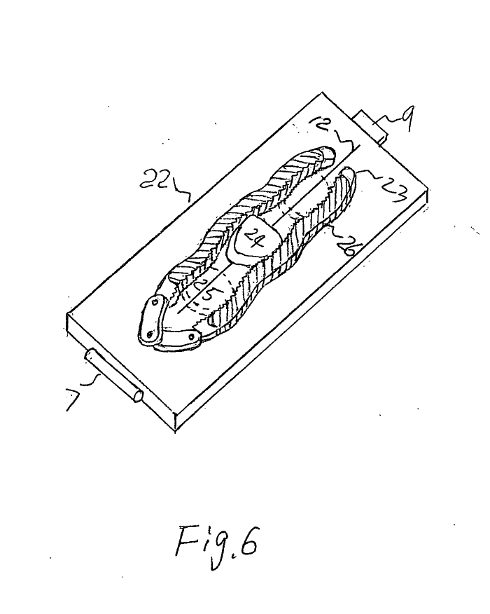

FIG. 6 shows a pill clamp with an articulation in each of its two arms 23. The longer segments of the two arms are parallel to each other and thus are able to hold more than one pills to be splitted at the same time. A iron bar 26 is embedded in the longer segment of each arm 23. Two or three magnetic tablets 25 are embedded in the cutting board along 22 the middle line 12. The size of each magnetic tablet 25 is at least the diameter of a regular pill , so that it maintains a sufficient magnetic field to pull the iron bars in the longer segments of the pill clamp towards the middle line 12.

Because of its narrower shape without the use of a spring and its wires to press the arms of the pill clamp, this pill clamp with magnet can be applied to the pill cutter with a swing blade available in the market, too.

What is claimed is:

1. the pill cutter is composed of a cylindrical or a square pill container with a blade, a cap for the cylindrical or square pill container with blade, and the cover for the cap, which is hinged at one end of the cap, has a clamp to hold the pill and functions as a cutting board for the pill.

2. the cylindrical segment with a blade according to claim 1, has longitudinal evenly spaced ridges to engage the longer corresponding longitudinal slots in the interior walls of the cap for the segment with blade, which only allows the segment with blade to move up and down within its cap instead of sideways and aligns the blade with the middle line between the two arms of clamp.

3. the pill container with blade according to claim 1, is shorter than its cap and its top margin is prevented from going past the top margin of its cap by two projecting tabs, so that the blade can not go lower than the opening of it cap.

4. the clamp for pills according to claim 1, has two arms integrated with spring wires to create gripping force and each arm has a finely serrated surface for better gripping, so that the clamp can grasp a pill of any shape and any size for cutting.

5. the clamp according to claim 4, wherein its two arm are kept slight apart to create a gap in between to accommodate the blade when the cap is closed.

6. the cover of the cap for the blade according to claim 1, functions as a cutting board for the blade and has a middle line, which centers the the two arms of the clamp holding a pill and is in alignment with the blade, thus obviating the need to visually align the blade with a pill as is the case with other pill cutters.

7. A pill clamp according to claim 1, can hold multiple pills for cutting at the same time, wherein each of the two arms consists of one short segment and one long segment, which are joined together by an articulation, which keeps the two long segments parallel to each other so as to hold multiple pills.

8. A clamp for the pill according to claim 1 has an iron bar in each of its arms, which has an articulation to join a long and short segments, and a cutting board for the pill according to claim 1 has magnetic tablets embedded in it, wherein the two arms of the pill clamp are drawn together by the magnetic field of the cutting board and can hold more than one pills for cutting at the same time.

9. the use of magnet in the cutting board and iron in the pill clamp according to claim 8, can be applied to the currently available pill cutter with a swing blade.
